(19) United States
(12) Patent Application Publication
(10) Pub. No.: US 2016/0306790 A1
(43) Pub. Date: Oct. 20, 2016

(54) PRESERVING CONSISTENCY IN DOMAIN-SPECIFIC BUSINESS PROCESSES THROUGH SEMANTIC REPRESENTATION OF ARTIFACTS

(71) Applicant: Xerox Corporation, Norwalk, CT (US)

(72) Inventors: Adrian Corneliu Mos, Meylan (FR); Nikolaos Lagos, Grenoble (FR); Jean-Yves Vion-Dury, Biviers (FR); Jean-Pierre Chanod, Meylan (FR)

(21) Appl. No.: 14/691,261

(22) Filed: Apr. 20, 2015

(51) Int. Cl. G06F 17/27; G06N 5/04; G06Q 10/06

(52) U.S. Cl. CPC G06F 17/2785; G06Q 10/067; G06N 5/04

(57) ABSTRACT

A method for semantic representation of artifacts includes receiving artifact data which includes transformation data and modification data. The transformation data represents transformations of respective artifacts from a source language to a target language. The languages can be domain-specific or generic. The modification data represents modifications in the source and/or target languages to one or more of the artifacts for which transformation data has been received. Based on the received artifact data, a semantic representation is generated. The representation includes objects representing the artifacts together with associated transformations and modifications. Objects are also associated with respective local contexts which denote a respective one of the languages. At least some of the objects in the semantic representation are associated with inferences based on inference definitions. Inconsistencies between objects having different local contexts can be identified, based on the inferences associated with these objects.

### BACKGROUND

The exemplary embodiment relates to modeling of business processes and finds particular application in connection with a system and method for preserving a consistent view over a set of process models in a multi-layered modeling system.

Business Process Management (BPM) addresses the methodology and tools that enable the management of business processes (BPs) as they evolve throughout their lifecycles. A Business Process Management Suite (BPMS) executes business processes and connects them to various enterprise resources, such as a personnel directory, various legacy applications, and, in some cases, to the organization's Service Oriented Architecture (SOA). An enterprise SOA typically manages the reusable technical services used to execute tasks that occur in business processes.

Business processes are often modeled in abstract terms by business-oriented users who have a good business knowledge and understanding of the various roles in the organization, but who are not necessarily familiar with the details of the Information Technology (IT) services that will ultimately be used to implement the processes in the SOA. A description of a process is generated by linking together a set of high level business concepts. The concepts in which the BP is initially modeled are then described in a more structured format using a language such as Business Process Model and Notation (BPMN) to describe the business process. Once the business process descriptions are created, a BPMN editor enables users to assign roles from the organization's hierarchy to human activities, to generate forms for manual tasks, to write business rules in scripting languages to condition various execution flows as well as to connect certain tasks to SOA services, among other features.

It would be desirable for domain-specific models to be the starting point in business process design. This could add an additional layer of modeling to the already complex BPM and SOA modeling and design layers. While this could give power of expressiveness and correctness to the business processes, it makes the modeling more complex. Currently, most approaches today do not provide for domain-specific modeling and struggle with coherence of various interconnected modeling artifacts. Some improvements have been made using hard-coded connectivity and hard-coupled software tools that exchange information in fully known formats for the required transformations. However, when companies want to have a degree of flexibility in choosing between software or BPM vendors, they often end up with incompatible environments that do not speak the same language and do not understand each other. Having one single exchange format for process models, such as Business Process Model and Notation (BPMN) helps to a certain degree, but this is limited to a technical representation of processes and does not take into account SOA composition. In addition it does not have any business domain semantics, so all domain knowledge is lost.

When adding an additional layer of domain modeling, strong meaning can be brought to business processes. However, the complexity of the environment is increased. To use such domain editors translations between domain-specific process designs and standard generic design languages (such as BPMN) that existing software suites can understand (e.g., BPM Suites from Oracle, IBM, TIBCO, SAP, and the like) are needed. However, translations between languages and diagrams alone are not sufficient because once they are performed, all traces are typically lost, and further changes to any layer renders the others invalid.

It has been proposed that the domain-specific modeling layers be connected to the more generic BPMN layer through a connectivity layer. See, Adrian Mos, et al. “Improving Process Robustness through Domain-Specific Model Transformations,” Enterprise Distributed Object Computing Conference Workshops (EDOCW), pp 188-193 (2013). In such an approach, the connectivity layer is responsible for taking modeling artifacts (process files, organizational structures, process activity properties) from a variety of tools in their respective form, and generating related artifacts used by other tools. For example, the process definition from a domain specific editor can be transformed into a BPMN process definition for any BPMN2 editor. This is advantageous because the various viewpoints in business process modeling suites involve different representations but they fundamentally relate to the same elements.

BPM notations and BPEL definitions have been mapped into Web Ontology Language (OWL) ontologies. See, Mario Lezoche, et al., “Semantic Lifting of Business Process models,” Workshops Procs. of the 12th Int'l IEEE Enterprise Distributed Object Computing Conf. (EDOCW 2008), pp. 120-126 (2008); M. A. Aslam, et al., “Expressing Business Process Model as OWL-S Ontologies,” Research Online, No. 439 (2006); and David Martin, et al., “OWL-S: Semantic Markup for Web Services. W3C Member submission,” (2004), available at http://www.w3.org/Submission/OWL-S. Semantic representations of heterogeneous data objects that are represented differently have also been proposed. Aletheia project consortium “Aletheia-semantic federation of comprehensive product information” (2010), available at http://www.aletheia-projekt.de. Some proposals focus on providing a more precise and explicit semantics through a translation of BPMN graphical representation into dedicated OWL ontologies. See, Marco Rospocher, et al., BPMN Ontology, available at https://dkm.fbk.eu/bpmn-ontology; and Chiara Ghidini, et al., “A formalisation of BPMN in Description Logics,” Technical Report TR 2008-06-004, FBK-irst, pp. 1-55 (2008), available at https://dkm-static.fbk.eu/resources/images/3/35/-3631-_BPMNOntology.pdf.

These systems, however, do not provide semantic interoperability between the heterogeneous representations of domain-specific process models and those generated by generic BPMN.

There remains a need for a system and method which provides information on differences between process models which allows changes in artifacts to be detected and inconsistencies to be understood.

### INCORPORATION BY REFERENCE

The following references, the disclosures of which are incorporated herein by reference in their entireties, are mentioned:

U.S. Pub. No. 20130232464, published Sep. 5, 2012, entitled DEPLOYMENT OF BUSINESS PROCESSES IN SERVICE-ORIENTED ARCHITECTURE ENVIRONMENTS, by Jacquin, et al., discloses methods of deploying business processes in different SOAs automatically.

U.S. application Ser. No. 13/963,240, filed on Aug. 9, 2013, entitled MONITORING OF BUSINESS PROCESSES AND SERVICES USING CONCEPT PROBES AND BUSINESS PROCESS PROBES, by Adrian C. Mos discloses a system and method for monitoring business processes including business activities and, in particular, to business processes running in a Business Process Management Suite (BPMS) which calls services running in a Service Oriented Architecture (SOA).

U.S. application Ser. No. 14/560,293, filed on Dec. 4, 2014, entitled HUMAN TASK MONITORING AND CONTEXTUAL ANALYSIS FOR DOMAIN SPECIFIC BUSINESS PROCESSES, by Kunal Suri, et al.

### BRIEF DESCRIPTION

In accordance with one aspect of the exemplary embodiment, a method for semantic representation of artifacts includes receiving artifact data. The artifact data includes transformation data representing transformations of respective artifacts from a source one of a plurality of domain-related languages to a target one of the plurality of domain-related languages. The domain-related languages can be generic or domain-specific. The artifact data also includes modification data representing at least one modification in one of the source and target domain-related languages for one of the artifacts for which transformation data has been received. Based on the received artifact data, a semantic representation is generated. This includes objects representing the artifacts and associated transformations and modifications. At least some of the objects are associated with respective local contexts which each denote a respective one of the plurality of domain-related languages. At least some of the objects in the semantic representation are associated with inferences based on inference definitions. Provision is made for identifying an inconsistency between objects having different local contexts, the inconsistency being based on the inferences associated with the objects.

At least one of the generating of the semantic representation, enriching the objects in the semantic representation, and providing for identifying an inconsistency may be performed with a processor.

In accordance with another aspect of the exemplary embodiment, a system for semantic representation of artifacts includes a semantic representation component which receives artifact data and inference definitions. The artifact data includes transformation data representing transformations of respective artifacts from a source one of a plurality of domain-related languages to a target one of the plurality of domain-related languages, and modification data representing at least one modification in one of the source and target domain-related languages for one of the artifacts for which transformation data has been received. The semantic representation component generates a semantic representation based on the received artifact data. The semantic representation includes objects representing the artifacts and their associated transformations and modifications. At least some of the objects are associated with respective local contexts which each denote a respective one of the plurality of domain-related languages. The semantic representation component enriches at least some of the objects in the semantic representation with inferences based on respective inference definitions and provides for identifying an inconsistency between objects having different local contexts, based on the inferences associated with the objects. A processor implements the semantic representation component.

In accordance with another aspect of the exemplary embodiment, a method for semantic representation of artifacts includes receiving artifacts in a source one of a plurality of domain-related languages from a first editing tool and transforming the artifacts into a target one of the plurality of domain-related languages. The domain-related languages can be generic or domain-specific. The artifacts in the target domain-related language are output to a second editing tool. Transformation data representing the transformations of the respective artifacts from the source domain-related language to the target domain-related languages which links the source artifacts to the target artifacts is generated. A semantic representation is generated, based on the transformation data. The semantic representation includes objects representing the artifacts and their associated transformations. At least some of the objects are associated with respective local contexts, each denoting a respective one of the plurality of domain-related languages. At least some of the objects in the semantic representation are enriched with inferences based on a set of inference definitions. Provision is made for outputting information based on the inferences.

At least one of the generating of the semantic representation, the enriching the objects in the semantic representation, and the outputting information may be performed with a processor.

### BRIEF DESCRIPTION OF THE DRAWINGS

FIG. 1 is a functional block diagram of a system for generating semantic representations of modeling artifacts generated by different modeling tools and for reporting information based on the semantic representations;

FIG. 2 is a flow chart illustrating a method for generating semantic representations of modeling artifacts generated by different modeling tools and for reporting information based on the semantic representations;

FIG. 3 illustrates an example of developing a travel planning business process in platform-independent form, using three layers.

FIG. 4 illustrates the execution of the process of FIG. 3 in one embodiment;

FIG. 5 illustrates the execution of the process of FIG. 3 in another embodiment;

FIG. 6 is a functional block diagram illustrating artifacts in the various layers;

FIG. 7 illustrates an example connection bridge meta-model.

FIG. 8 is a visual representation of a part of the resulting semantic model;

FIG. 9 illustrates exemplary transformations and modifications;

FIG. 10 illustrates an example travel process in domain-related language;

FIGS. 11A, 11B, and 11C show an example travel process which has been transformed from the platform-independent form to the semantic form;

FIGS. 12A, 12B, and 12C show an example transformation of a transition step from a platform-independent to a semantic space representation;

FIG. 13 illustrates the automatic explanation of inference leading to fact that Notify of information step is after the Check Address step; and

FIG. 14 illustrates inferred information for the first Notify of information step in the global context (using before, directlyBefore, after predicates); and

FIG. 15 illustrates the inference process leading to detection of an inconsistency in the Notify of information step.

### DETAILED DESCRIPTION

The exemplary embodiment provides a system and method for preserving a consistent view over large number of process models in a multi-layered modeling system. It finds application in concept-based deployment and monitoring, as described, for example, in U.S. Pub. No. 20130232464 and U.S. application Ser. Nos. 13/963,240 and 14/560,293.

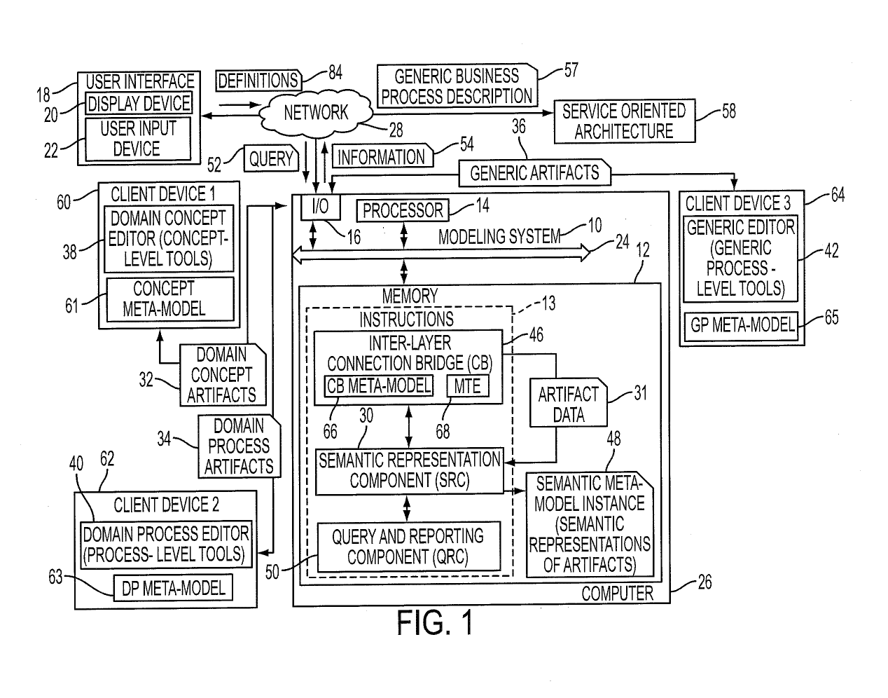

FIG. 1 illustrates a Business Process Management and Service Oriented Architecture environment which utilizes domain-specific concepts as the underpinning of BPM and SOA solutions. The architecture includes a computer-implemented system 10 for modeling business processes.

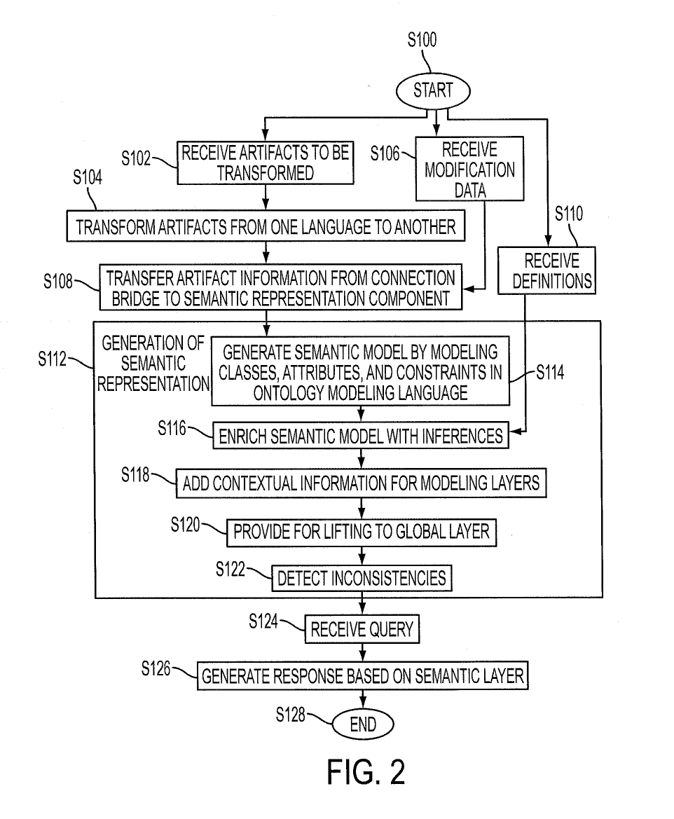

The illustrated computer system 10 includes memory 12 which stores instructions 13 for performing the method illustrated in FIG. 2 and a processor 14 in communication with the memory for executing the instructions. The system 10 also includes one or more input/output (I/O) devices, such as a network interface 16. The I/O interface 16 may communicate with one or more user interfaces 18, each with a display device 20, for displaying information to users, and a user input device 22, such as a keyboard or touch or writable screen, and/or a cursor control device, such as mouse, trackball, or the like, for inputting text and for communicating user input information and command selections to the system. The various hardware components 12, 14, 16 of the modeling system 10 may be all connected by a data/control bus 24.

The computer system 10 may include one or more computing devices 26, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 14 and memory 12 may be combined in a single chip. Memory 12 stores instructions for performing the exemplary method as well as the processed data.

The network interface 16 allows the computer to communicate with other devices via a link 28, such as computer network, e.g., a local area network (LAN) or wide area network (WAN), or the Internet, and may comprise a modulator/demodulator (MODEM) a router, a cable, and and/or Ethernet port.

The digital processor device 14 can be variously embodied, such as by a single-core processor, a dual-core processor (or more generally by a multiple-core processor), a digital processor and cooperating math coprocessor, a digital controller, or the like. The digital processor 14, in addition to executing instructions for performing the method may also control the operation of the computer 26.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The system 10 includes a semantic representation component (SRC) 30, which receives, as input, data 31 representing modeling artifacts (software components) 32, 34, 36. The artifacts 32, 34, 36 themselves are generated and modified by respective sets of business process tools 38, 40, 42, such as one or more domain concept level tools 38, one or more domain process level tools 40, and one or more generic process level tools 42 using respective representation formats. The artifacts can include concepts, processes, steps, transitions, and the like which are commonly modeled in the domain-related modeling languages employed by the respective tools. The domain-related language used for a domain can be domain-specific or generic, such as BPMN. The artifact data 31 includes transformation data 44 and modification data 45. Some or all of the artifact-related data 31 may be received by the SRC 30 from an inter-layer connection bridge 46.

The SRC 30 outputs a semantic representation 48 of the artifacts 32, 34, 36, and the modifications/transformations to/between them. A querying and reporting component (QRC) 50 receives as input a query 52 and outputs responsive information 54 that is based on the semantic representation 48.

The SRC 30 stores, in the semantic representation 48, a semantic meta-model instance 56, which is a representation of the connections between the elements in the various layers that would otherwise be lost after transformations and modifications, allowing consistency checks and other evaluations to be performed. The SRC 30 externalizes this transformation/modification information as objects in the semantic layer 48. The semantic layer stores all the transformation traces, when they occur. The SRC also uses inference to generate useful knowledge about process models, originally encoded in their various representation languages, from the stored transformations. Using the information in the semantic layer 48, the QRC 50 is able to respond to queries about process models 32, 34, 36, etc., at any level and return results associated to the various points of view of the various stakeholders.

The business process tools 38, 40, 42 are used to progressively develop a business process description 57 in a form which can be exported to and implemented by Information Technology (IT) services in a service oriented architecture (SOA) 58. The tools are based on meta-models, each containing various elements in a respective domain-specific language (DSL) that are relevant to and correspond to graphical editing of constructs of business processes.

The illustrated domain concept tools 38 are used by managers to generate a domain-specific business process using selected ones of a set of domain-specific concepts. In the case of a travel planning business process, for example, these may include selecting concepts such as “client setup”, “book flight,” “book hotel,” “book car,” “generate client package,” and the like. In the illustrated embodiment, the domain concept tools 38 are in the form of an editor accessible to the user of a client device 60, the editor having access to or incorporating a concept level meta-model 61.

The domain process-level tools 40 are used by someone more knowledgeable about business process flows to formulate an ordered sequence from the concepts. In the illustrated embodiment, the domain process-level tools 40 are in the form of an editor accessible to the user of a respective client device 62, the editor having access to or incorporating a domain process (DP) level meta-model 63.

The generic process level tools 42 are used to generate and manipulate artifacts, such as business processes, in a generic business planning notation, such as BPMN. In the illustrated embodiment, the generic process level tools 42 are in the form of an editor accessible to the user of a respective client device 64, the editor having access to or incorporating a generic process (GP) level meta-model 65.

The Unified Modeling Language (UML) may be used for specifying and constructing the business artifacts (domain-specific concepts, domain processes, and BPMN processes) used in the various layers 32, 34, 36, while the Web Ontology Language (OWL) may be used for generating the semantic representation 48.

User interfaces 18 and client devices 60, 62, 64 may each include memory, a processor, and one or more input/output devices, as for computer 26, in addition to a display device 20 and user input device 22. As will be appreciated the tools 38, 40, 42 may be hosted by different computing devices, as shown, or otherwise made accessible to the people who make use of these tools. In some embodiments, one of the client devices 60, 62, 64 may serve as the interface 18.

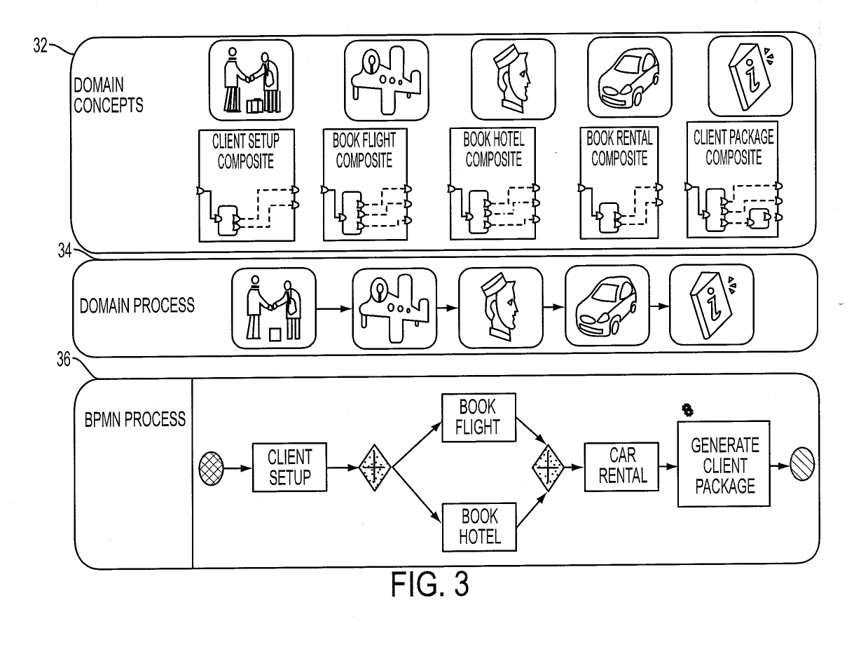

FIG. 3 illustrates an example of developing a travel planning business process in platform-independent form, such as BPMN, which may be generated using the business process tools. A problem with the multilayered modeling approach illustrated in FIG. 3 is that any of the artifacts (e.g., concepts 32, domain process 34 and BPMN process 36) can be modified by various stakeholders. For example, when a business process needs to be improved, domain experts may enact changes using the domain process editor 40. If a BPMN process needs to be updated for BPMS specific reasons or in order to improve performance, such changes can be done by a BPMN expert in the BPMN editor 42. Changes to business concepts, for example related to SOA connectivity (how a business concept is related to services in the enterprise architecture) can be done by architects and domain experts with the concept editors 38. Such changes in one layer may sometimes influence models used in the other layers. Whether or not the changes propagate to other layers (and how much) is determined by the transformation semantics between layers. Automatic transformations are performed by the inter-layer connection bridge 46 to generate one layer from another.

The inter-layer connection bridge 46 may be used to automatically transform the artifacts 32, 34, 36 generated by tools at one level into artifacts used at another level. For example, the connection bridge 46 may take as input a domain business process 34 from client device 62 and convert it to a generic business process 36 in BPMN, which is output to client device 64. The connection bridge 46 may be configured, for example, as described in Adrian Mos, et al. “Improving Process Robustness through Domain-Specific Model Transformations,” Enterprise Distributed Object Computing Conference Workshops (EDOCW), pp 188-193 (2013), hereinafter, Mos 2013. The transformation of artifacts from one level to another may be achieved using a core, centralized connection bridge meta-model 66 which represents artifacts 32, 34, 36, from the two or more layers in a common modeling language, and a model transformation engine 68, which transforms the artifacts from the different layers into the common format and vice-versa, as described in Mos 2013. However the connection bridge of Mos 2013 makes no provision for preserving the sources of transformation, i.e., after a transformation is performed by the model transformation engine 68, the system 10 does not retain the connection between the source of the transformation and the target. Additionally, it is very difficult to determine the implications of changes in one layer with respect to other layers.

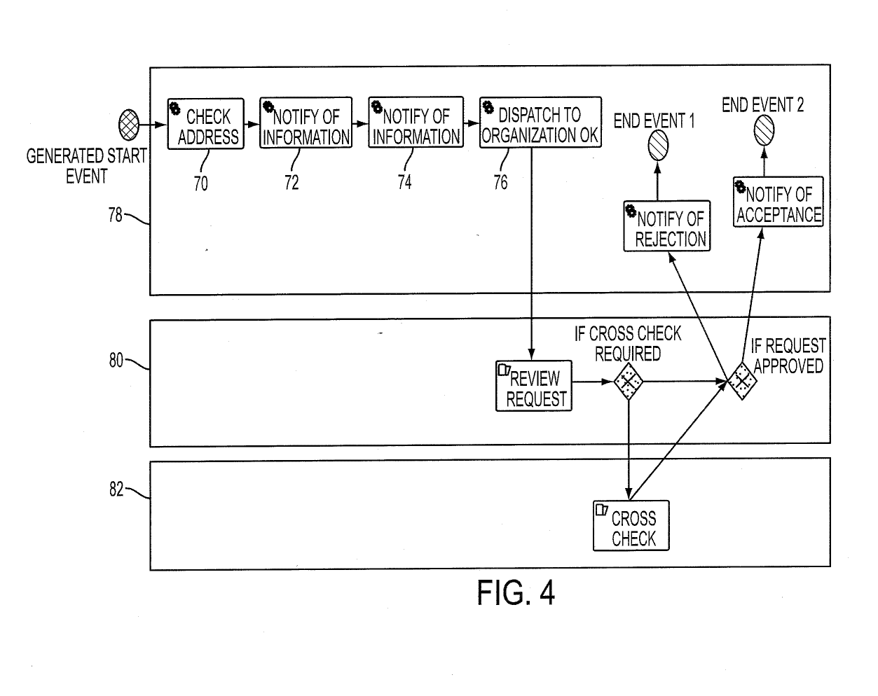

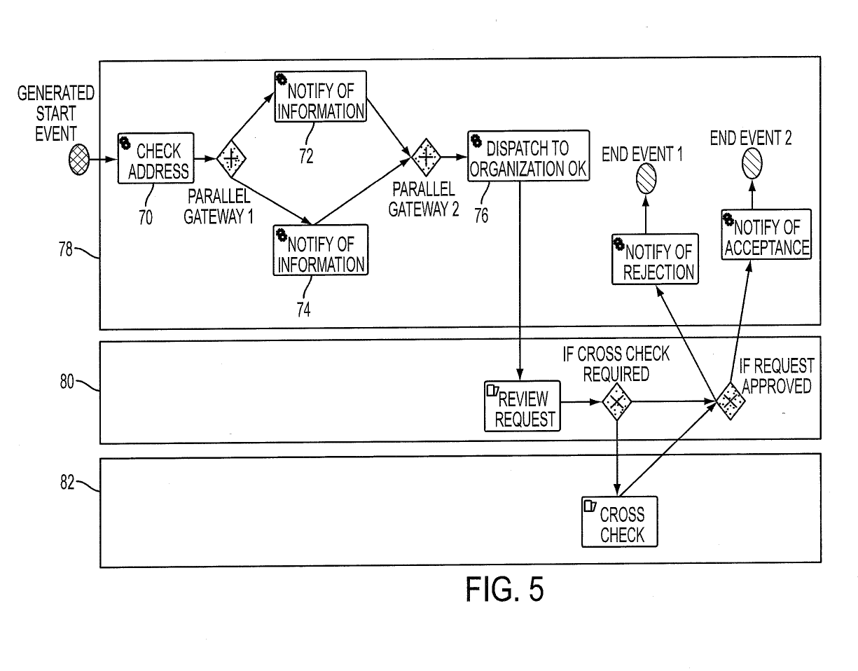

For example, consider the BPMN process 36 illustrated in FIGS. 4 and 5. Both include a set of elements, such as steps 70, 72, 74, 76, etc., to be performed by different services 78, 80, 82 in the SOA 58. The two processes achieve the same outcome, but in the process of FIG. 4, steps 72 and 74 are performed sequentially, whereas in FIG. 5, these steps are performed in parallel. The BPMN expert identifies the latter process as being faster, overall, since the two steps 72, 74, are being performed at the same time.

While the illustrated simplified example is relatively easily checked to determine whether the BPMN processes are inconsistent (e.g., according to predefined rules), when looking at a large collection of processes it is almost impossible for the various stakeholders to understand problems with process evolutions, changes, and differences or inconsistencies with business goals. The SRC 30 and QRC 50 of the exemplary system 10 help to address these problems and answer questions that are posed by the different stakeholders based on their own concerns and perspectives (business vs. architect vs. technical . . . ).

In the exemplary embodiment, to keep track of the transformations made by the connection bridge between DSLs and the modifications to the artifacts with the respective editors 38, 40, 42, the SRC receives transformation data 44 and modification data 45. Transformation data 44 represents a transformation of an artifact from a source level (layer) to a target level (layer), i.e., a transformation from a source DSL to a target DSL. Modification data 45 represents the modification of one of the transformed artifacts in only one of the source and target layers, i.e., within one DSL. The modifications may be source modifications or target modifications. Source modifications are each a user modification to an existing artifact 32, 34, in the source DSL (after a transformation has been performed). Target modifications are each a user modification to an existing artifact 34, 36 in the target DSL (after a transformation has been performed). For example, when a target modification to an artifact 34 occurs in the target DSL, a representation of the modified artifact is linked to the representation of the artifact in the target DSL prior to its modification and thereby is also linked to the representation of the corresponding artifact 32 in the source domain from which the artifact 34 was previously generated through a transformation. Similarly, when a source modification to an artifact 32 occurs in the source DSL, a representation of the modified artifact is linked to the representation of the artifact in the source DSL prior to its modification and thereby is also linked to the representation of the corresponding artifact 34 in the target domain which was previously generated from artifact 32 through a transformation.

FIG. 2 illustrates a method which may be performed with the system of FIG. 1. The method begins at S100.

At S102, artifacts to be transformed from a first (source) DSL to a second (target) DSL are received by the system from one of the editors 38, 40, 42.

At S104, the received artifacts in the source DSL are transformed (by the CB transformation engine 68) into artifacts in the target DSL, via the intermediate meta-model 66, and are stored in a meta-model instance in a CB layer 83.

At S106, modifications, when they occur in one of the domain layers, are received by the system and representations thereof may be stored in the CB layer 83.

At S108, artifact data 31 representing the artifacts and the transformations between them generated at S104 and/or modifications made to them detected at S106, are output by the CB and received by the SRC 30 (e.g., from the connection bridge).

At S110, a set of one or more user-input inference definitions 84 is received by the SRC 30 (e.g., from the user interface 18).

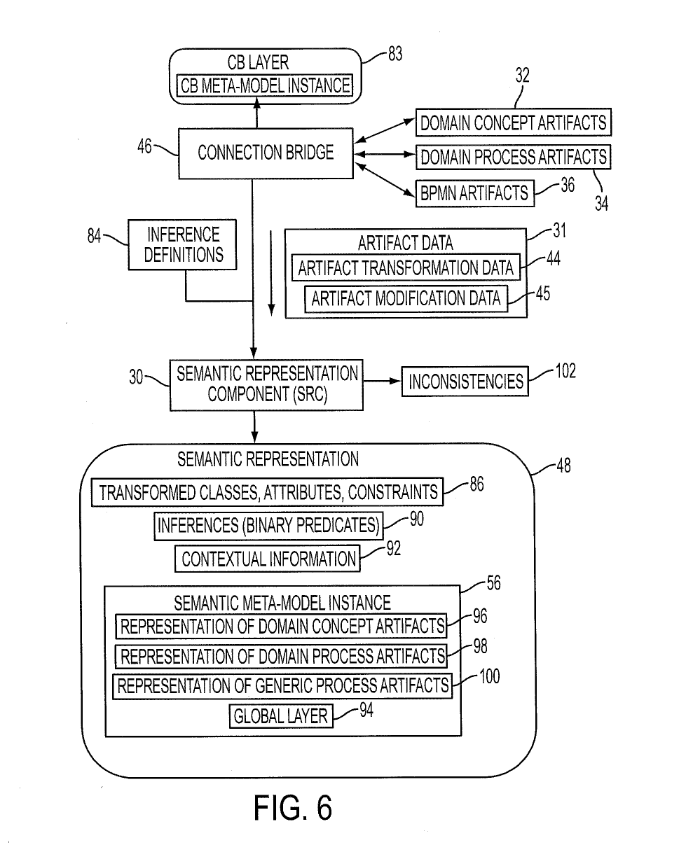

At S112, a semantic representation 56 is generated, by the SRC 30, as illustrated in FIG. 6. In the representation 56, objects represent the artifacts and transformations and modifications to/between them. S112 may include the following substeps:

At S114, classes, attributes, and constraints 86 are modeled in an ontology modeling language.

At S116, the semantic meta-model generated at S114 is enriched with inferences 90, based on the input inference definitions. Some of the inferences each describe a semantic relation between two or more of the objects.

At S118, contextual information 92 is included in the semantic meta-model to denote the source layers 32, 34, 36 from which the objects in the semantic meta-model were generated.

At S120, a global layer 94 is generated in the semantic layer 48 and provision is made for a user to request lifting of objects from other layers 96, 98, 100 to the global layer 94.

At S122, inconsistencies 102 in the semantic representation 48 may be detected, by the SRC. For example, after a user has modified one of the layers 32, 34, 36, it may be inconsistent with another. The inconsistencies 102 may be stored in memory 12 until the system is queried and/or, at least in some cases, may be automatically output.

At S124, a query 52 is received from a user and at S126, responsive information 54 is output. The information is generated by the QRC 50, based on the semantic representation 48, e.g., includes information identifying inconsistencies 102 that are relevant to the particular user, or other information which is derived from the semantic representation. Information may also be output automatically, without querying by a user. The method ends at S128.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 26, (for example, an internal hard drive of RAM), or may be separate (for example, an external hard drive operatively connected with the computer 26), or may be separate and accessed via a digital data network such as a local area network (LAN) or the Internet (for example, as a redundant array of inexpensive of independent disks (RAID) or other network server storage that is indirectly accessed by the computer 26, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

The following sections describe the structure and functionality of the connection bridge (CB) 46, SRC 30, and associated QRC 50 in more detail.

### Connection Bridge 46

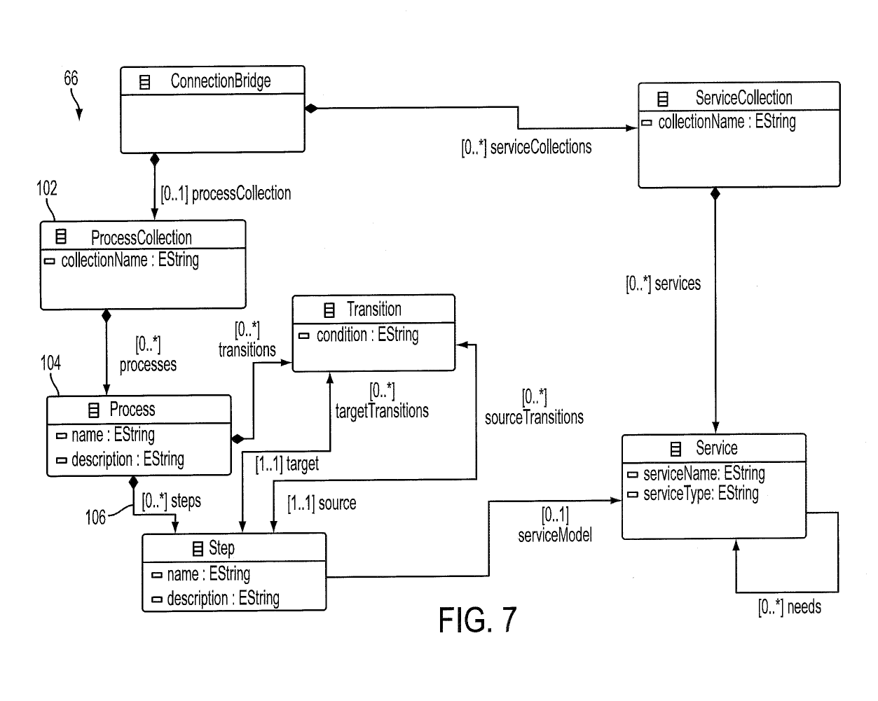

The CB meta-model 66 is a central, simplified representation of the main generic concepts common to business process descriptions, such as activity, flow, gateway, and the like in which business processes generated or edited with different editors 38, 40, 42 can be represented in a common representation form. FIG. 7 provides an example of such a meta-model 66 (a simplified model of an actual model of the information collected by the CB).

The meta-model 66 may be significantly simpler than the fully-fledged BPMN because its objective is simply to extract the essence of the structure of various business processes, and not to offer a complete modeling language. Converting between an instance of the common meta-model 66 and the domain-specific meta-models 61, 63, 65 is performed using model-based transformations. The transformations are written at meta-model level and their execution is performed at model instance level. The transformations from domain-specific meta-models to the common meta-model may be triggered by modules (not shown) that are connected to the editors 38, 40, 42. These modules may be plug-ins that integrate into the editors transparently or may be integral with the editors themselves. The modules may communicate with the model transformation engine 68, which is responsible for executing the transformations. Once transformed into an instance of the common meta-model 66, the processes and other artifacts can be converted to another domain-related language, such as the generic language (e.g., BPMN). The conversions between the generic language and the simplified common language may be performed using meta-model operations.

### Semantic Representation Component

The SRC 30 preserves a consistent representation of all the main artifacts in the various layers as well as their inter-relations in the semantic representation 48. The primary source of information for the SRC 30 is the inter-layer connection bridge (CB) 46, which sends relevant data 44, 45 each time a new transformation or modification occurs. Upon receiving such data, the SRC 30 checks the consistency of the data and infers new facts.

Generation of Semantic Representation Artifacts

FIG. 6 illustrates the relationships between the various layers 32, 34, 36, 48, which comprise the instances of the respective meta-models. The artifacts that constitute the backbone of the SRC system 30 can be generated as follows:

1. A direct mapping of information 31 is extracted from the CB meta-model 66 and used to generate a semantic meta-model instance 56.

2. Additional semantic information 90 that aids in inferring new facts is added to the semantic meta-model instance.

3. A semantic representation 96, 98, 100 of the different layers 32, 34, 36 is generated and a corresponding mechanism to manipulate the objects in the SRC space can be applied to it.

As modeling languages, OWL2 (http://www.w3.org/TR/owl2-overview/) and SWRL (http://www.w3.org/Submission/SWRL/) may be used, with the corresponding terminology. However, other formalisms could also be used as long as they allow the operations described below to be performed.

From the CB Meta-Model to a Semantic Model

It is to be appreciated that the CB meta-model 66 illustrated in FIG. 7 is only an example of what can be used as the basis of the connectivity layer 83. As an example, a version of such a meta-model from the Eclipse Mangrove project (http://www.eclipse.org/mangrove/) can be used. The model 66 includes a set of data objects 102, 104, etc., represented by boxes, such as processes, steps, transitions (what happens for going from one step to the next) with conditions (e.g., if . . . , then . . . ). Arrows 106 between the boxes represent directed associations, e.g., a set of steps are combined to form a process, which in combination may form a collection of processes. Each data object includes attributes, such as a name, a state, a description, and various modeler-definable properties. The CB meta-model 66 is transformed into a semantic model 48 in step S112. This may include modeling UML classes, associations, attributes, and cardinality constraints (S114). Taking as an example OWL2 as the modeling language, the following transformations may be carried out:

1. The UML classes Step, Transition and Process are modeled as classes in OWL2.

2. The directed associations steps (linking a step to the process to which it belongs), transitions, targetTransitions, source Transitions, target (is the inverse of targetTransitions), and source (is the inverse of source Transitions) are modeled as object properties, with domains and ranges for the corresponding classes. The property transitions links the processes to the transitions they include while source Transitions represents the fact that a transition is the source of a step (link between a transition and a step) and targetTransitions the corresponding targets of a step (link between a transition and a step).

3. The attributes name and description are transformed into datatype properties.

4. The constraints on cardinality 0 . . . * correspond to standard object properties in OWL2. The cardinality constraint 0 . . . 1 is modeled as a functional property (an object or datatype one according to whether it is a relation or attribute in the UML diagram). For the cardinality constraint 1 . . . 1, the maxCardinality can be used with the limitations outlined in Jesper Zedlitz, et al., “From UML to OWL 2,” Communications in Computer and Information Science Volume 295, pp 154-163 (2012).

As will be appreciated, the semantic model 48 includes only a portion of the information associated with the various layers which is useful in generating information 54.

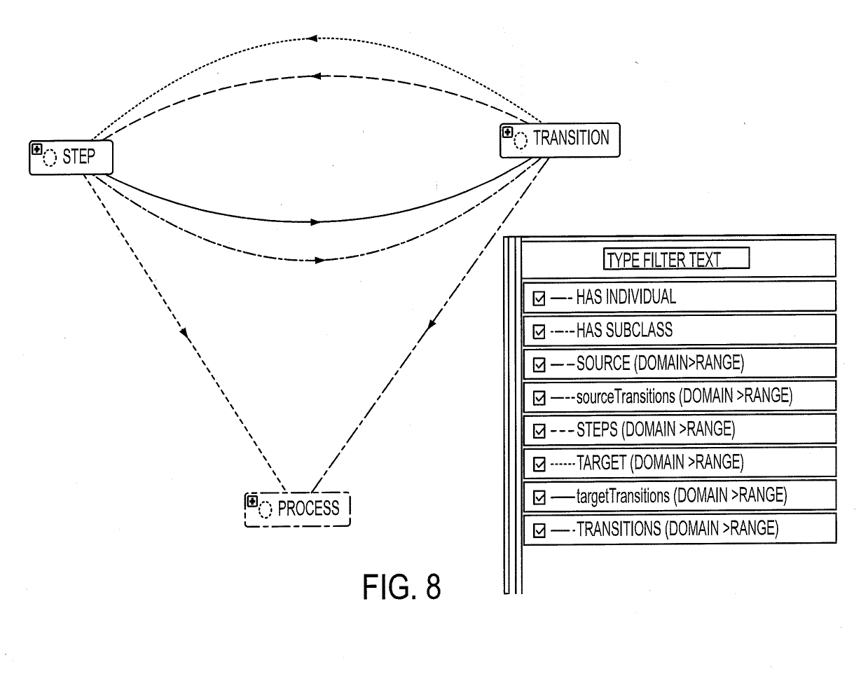

FIG. 8 is a visual representation of a part of the resulting semantic model 48 showing the relations between the Process, Step, and Transition classes, as explained above.

Enrichment of the Semantic Model

The SRC 30 is able to perform semantics-based inference that is not possible in the CB space. In addition to the information available in CB space, at S116, other definitions can be inserted in the SRC space. These may be user-defined inference definitions 84 appropriate to the business. A definition may be of the form “A before B is true.” Example formalisms are described below.

For example, the inferences 90 generated from the definitions 84 can generate additional facts that may include binary or n-ary predicates. Each binary predicate includes two objects and a semantic relation R between them. The semantic relation R can be a temporal relation, such as before, after, in-parallel-with, etc., or a property relation, such as is-larger-than, is-smaller-than, is-shorter-than, is-longer-than, and so forth In n-ary predicates, n is more than two, each n-ary predicate including n objects and a semantic relation between them. For example, the temporal ordering of tasks can be represented in terms of binary predicates between subsequent tasks. In that case, the expression:
(Task₁, before, Task₂)

may be used to denote that Task₁ has to take place before Task₂. An example would be the constraint that all payment operations must be done after processing invoices corresponding to the operation. The binary predicate before in the above example could have more semantic properties attached to it, such as transitivity, which could be used by a reasoning engine to infer additional information. For example, if Task₂ also has to take place before Task₃, it can be inferred that Task₁ has to take place before Task₃. The possible expressivity and inference power is related to the chosen formalism adopted in the SRC space.

Representation of the Modeling Layers in the Semantic Model

As noted above, there are different modeling layers, in the “non-semantic” space, such as the domain process layer, which includes the artifacts 34, and the BPMN process layer, which includes the artifacts 36. To keep the provenance of the objects (in terms of the layer in which they originated) in the semantic space, contextual information 90 is stored (S120). Each layer is represented as a separate context (its local context) 96, 98, 100, in the semantic space 56. For example, to assert that that an object S₁ has as a source transition T₁ in a given local context, such as LOCALCON1, this can be denoted by the expressions:
(S₁, isInContext, LOCALCON1)
(T₁, isInContext, LOCALCON1)
(S₁, sourceTransition, T₁)

In the case of the system shown in FIG. 1, for example, there are three local contexts in the semantic model: LOCALCON1, LOCALCON2, AND LOCALCON3, corresponding to the domain concept layer 32, domain process layer 34, and generic process layer 36, respectively. All the local contexts are disjoint with each other. The SR dataset 48 is then a union of the information that is in all local contexts 96, 98, 100, plus a global context 94, denoted GLOBALCON, which has the role of a transcending space, meaning that objects that are in different local contexts can also belong to the global context.

The operation of mirroring an object that belongs to a local context to the global context is referred to as lifting. Lifting performs the following operations: it creates a new object S₂ in the global context, then links the initial object S₁ and the new one via a predicate (mapsTo) that preserves its provenance, and then places the new object into the global context.
lifting (S₁,S₂)->(S₁, mapsTo, S₂) AND (S₂, isInContext, GLOBALCON)

Binary (or n-ary if the formalism allows such a representation) predicates can also be lifted but in that case, at least two of the objects that participate in the relation should also be lifted—one being at the domain (source) of the relation and the other at its range (target).

Objects are allowed to be lifted (S118) only if they are also represented in the CB metamodel 66 (as they are the ones that can transcend contexts by design) or if they are added in the semantic space as described above.

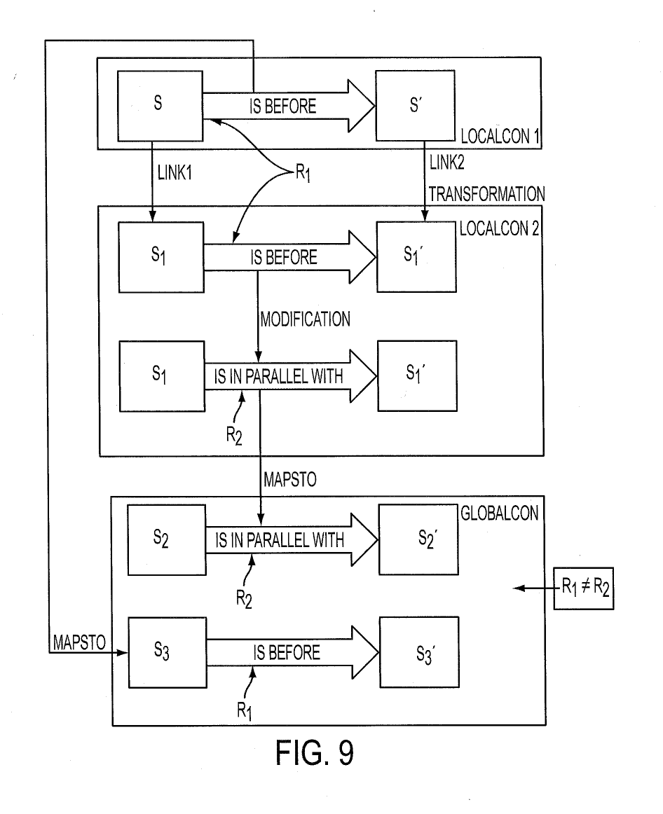

FIG. 9 illustrates objects in the semantic space. Object S is in a relation R₁ (is before) with object S′ in LOCALCON 1. A transformation of the relation (via the common CB meta-model) into a different DSL results in the relation S₁ is before S₁′. This is stored in LOCALCON 2, where links Link1 and Link2, indicate the connections between the corresponding source and target objects (S₁ with S and S₁′ with S′). A user subsequently modifies this relation to R₂ generating the relation S₁ is in parallel S₁′, which is stored in LOCALCON 2.

At some point, a user decides to lift the binary predicate S,R₁,S′ in LOCALCON 1 and the binary predicate S₁,R₂,S₁′ in LOCALCON 2 to the global layer creating two new binary predicates. The objects S₂, S₃, S₂′, S₃′ in the new predicates are mapped to the corresponding objects S₁, S, S₁′, S′ from which they are derived. Thus, when the two predicates in the global layer are being compared, it is clear that S₂ and S₃ are both derived from S, i.e., relate to the same artifact, and S₂′ and S₃′ are both derived from S′ i.e., relate to the same artifact. Thus an inconsistency can be detected if the two semantic relations R₁ and R₂ are defined as being disjoint (i.e., inconsistent) with each other.

Coupling the SRC with the Global Architecture

Two arrangements for coupling the SRC 30 with the rest of the system 10 are contemplated. In the first, a strong interaction is provided between the SRC 30 and the components 38, 40, 42 that modify the models. In this case, the components 38, 40, 42 may be “SRC aware” and may use an API to exchange information with the SRC, so that the SRC can update its internal representation 48 in a consistent way, and/or react directly to any problems potentially induced by components.

The other arrangement is to have a weak coupling, where the SRC analyses the products of model transformations (typically data structures encoded according to dedicated formats such as XML), and extracts change descriptions or analysis reports by using dedicated algorithms. An advantage of this arrangement is that the compatibility with the editors and their plug-ins can be weaker, hence minimizing the impact on existing components.

The two approaches can be combined and/or chosen in accordance with the applicative domain relevance.

### Query and Reporting System

In an exemplary embodiment, the SRC 30 maintains a Resource Description Framework (RDF) store and an OWL representation of the semantic model instance 48. This can be queried using standard querying language (e.g., SPARQL or other RDF query language) and its basic consistency can also be verified by existing reasoners. Dedicated properties (depending on the applicative models) can be elaborated and checked through specific inference mechanisms or queries.

The QRC 50 can then be used for powerful business process tools where various users can launch queries pertaining to their own domains of expertise.

For example, a user of the interface 60 sends a query 52 requesting information on inconsistencies between semantic relations involving two artifacts. The QRC queries the semantic model instance 48 and identifies inconsistencies between the respective layers in the model 48. Other queries can be made, such as: is the system in a consistent state?, and so forth.

The method is not limited to identifying inconsistencies between relations. It can also be used, for example, to evaluate other aspects of the semantic representation, such as whether one or more processes can be performed within a given time, such as the time taken by another process, and thereby determine, for example whether processes A and B can be performed in sequence and also performed in parallel with process C. Another use may be in determining the overall time taken by a complex process. Other uses may be in detecting loops, violations of structural information.

For example a query could be made such as how many processes occur between payment and shipping, or how long does this part of the process take.

### Illustrative Example

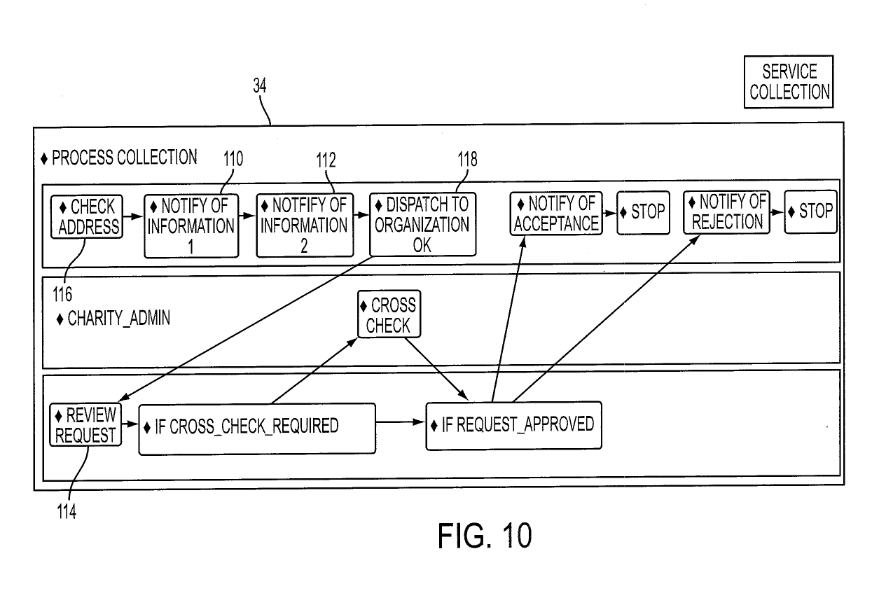

The steps described above are now illustrated with an example travel process illustrated in domain-specific language (DSL) in FIG. 10.

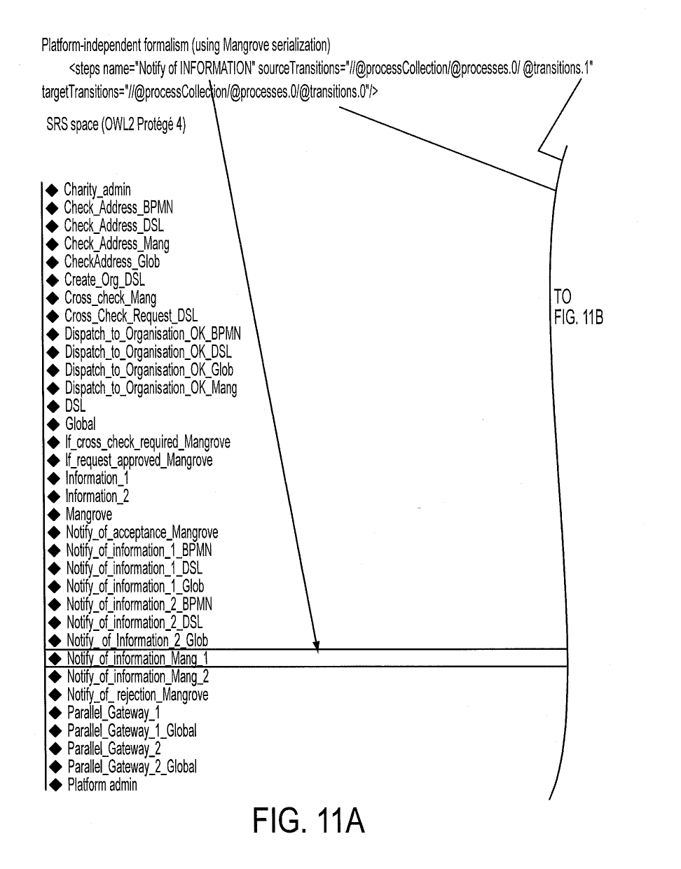

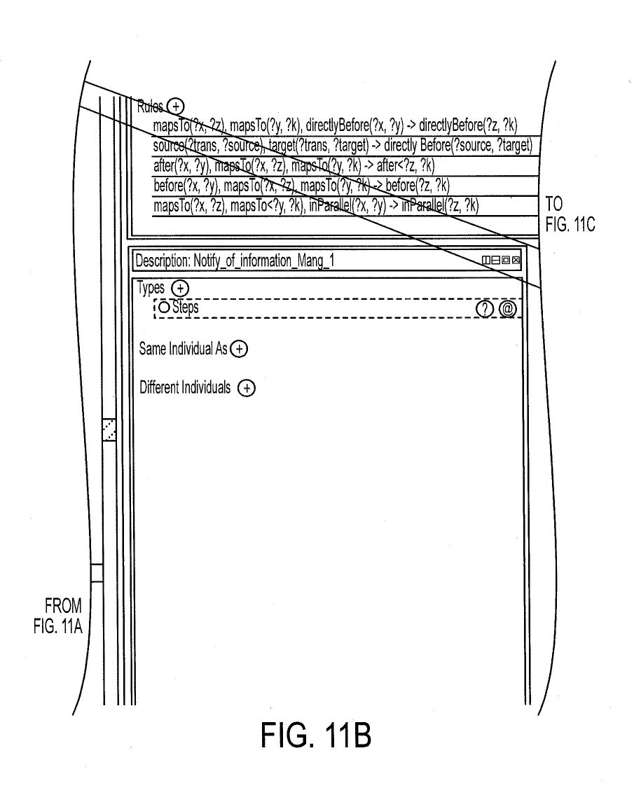

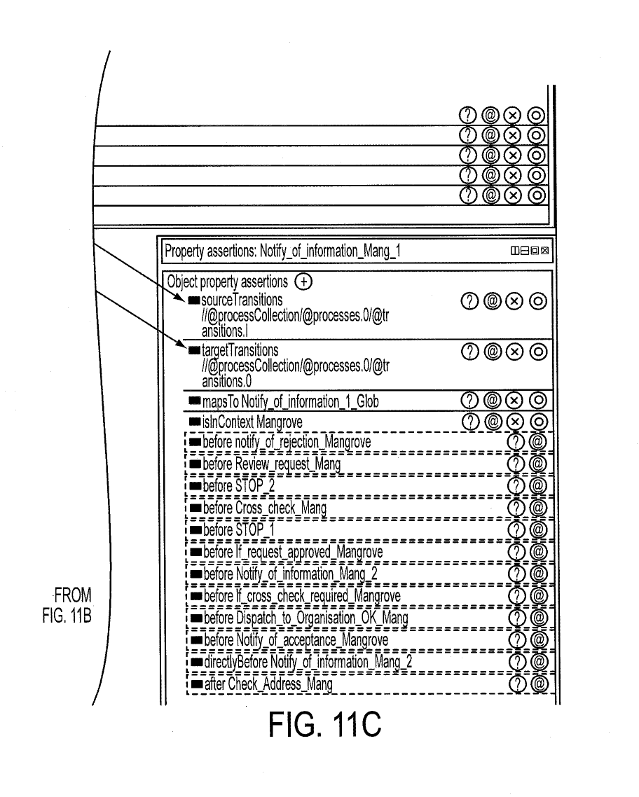

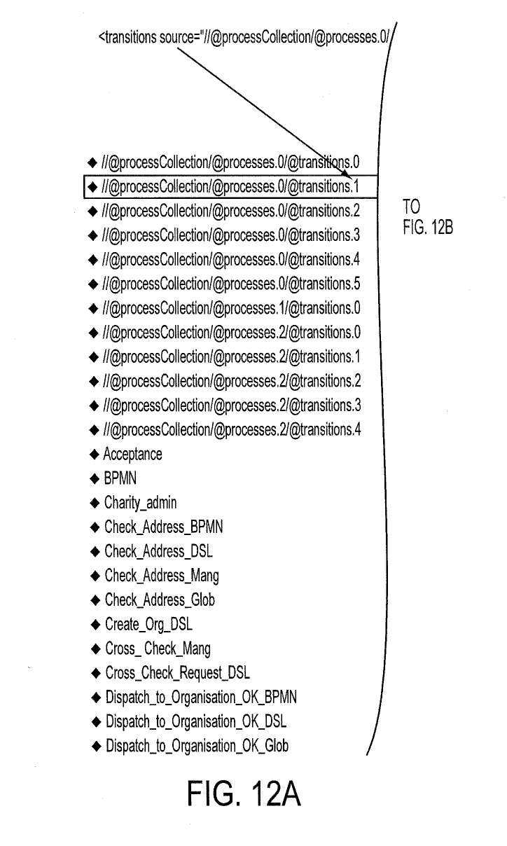

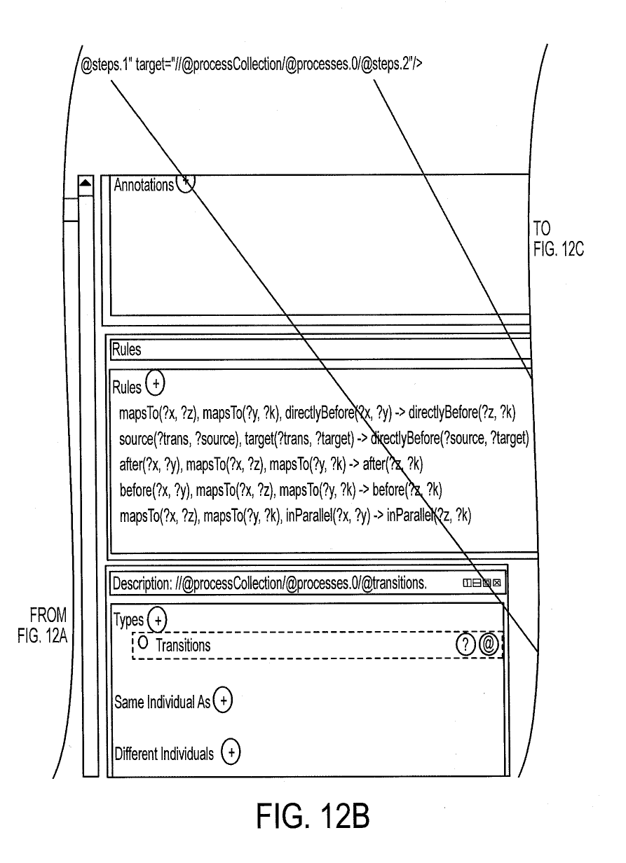

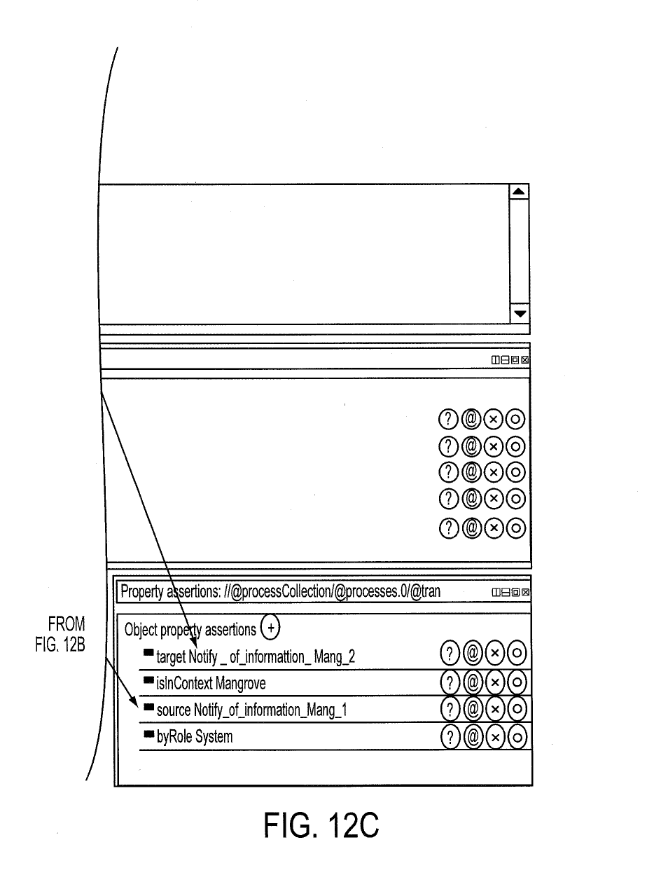

In S114, the example travel process is transformed, from the platform-independent form to the semantic form. FIGS. 11A, 11B, and 11C (generated with Protégé 4.2 (http://protege.stanford.edu/) illustrates an example of this for the step Notify of information. As shown, the step 110 “Notify of information” is transformed into an instance of the class Steps in the SRC space. The corresponding transitions are also transformed into instances (of a class called Transitions that is not shown here) and each transition is linked with the step instance through corresponding OWL2 object properties (i.e., source Transitions and targetTransitions in FIGS. 12A, 12B, and 12C).

The local context to which this information belongs is also represented by the is-In-Context object property.

As a second step in the SRC model creation (S116), the following semantic relations are added to represent the ordering of the steps:

directlyBefore—to represent when a step is directly before another one in the sequence.

directlyAfter—the inverse of directly-Before, represented as the triple (directly-After, inverseOf, directly-Before) in the SRC space,

before—to represent when a step is before another step. This property is defined as transitive. Every directlyBefore property is actually a specialized before property denoted in the SRC space as (directlyBefore, subPropertyOf, before).

after—the inverse of before, represented as (after, inverseOf, before) in the SRC space. This property is also transitive. Every directly-after property is actually a specialized after property denoted in the SRC space as (directlyAfter, subPropertyOf, after). When two steps are linked with a before property they cannot also be linked with an after property, defined in the SRC space by an SRC rule (before, disjointWith, after).

InParallel—denotes that two steps are taking place in parallel. For the purpose of the example, when two steps are linked with the before or after properties they cannot be also linked with the inParallel property. This is defined in the SRC space by two SRC rules (inParallel, disjointWith, before) and (inParallel, disjointWith, after).

To infer when the semantic relations defined above hold between two steps in the SRC space, a rule is defined (S110). For example, in SWRL formalism, this case can be represented as follows:
source(?trans, ?source), target (?trans, ?target)->directlyBefore (?source, ?target)

This denotes that if a transition has an entity related to it via the source predicate (this entity is a Step as it can be inferred from the semantics of the predicate source, as explained above) and the same transition has another entity related to it via the target predicate (this entity is a Step as it can be inferred from the semantics of the predicate target, as explained above) and these two entities (or steps) are related to each other via the directlyBefore predicate.

That, in relation to the transformation done above, allows the inference at S116:
(Notify_of_information_1, directlyBefore, Notify_of_information_2)

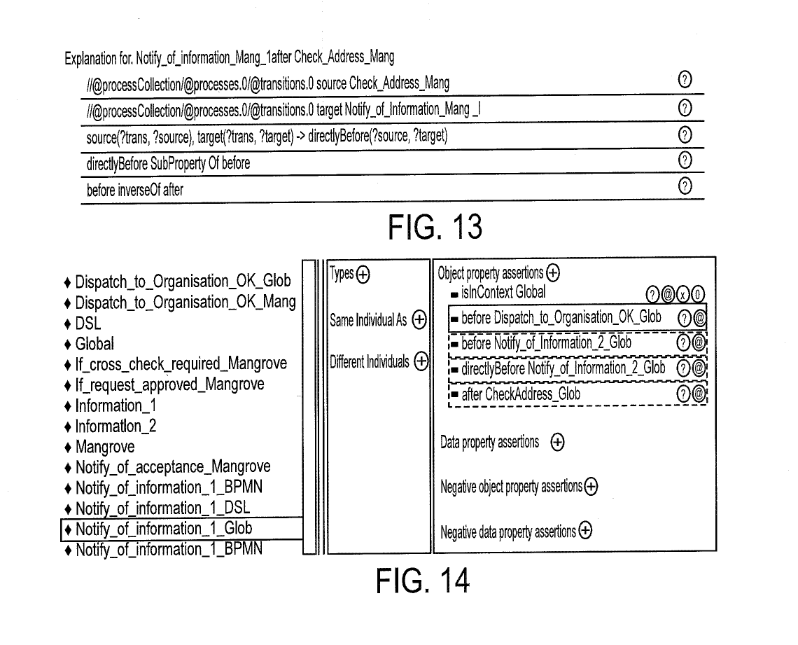

This inference means that the first notification step 110 occurs directly before the second notification step 112 (FIG. 9). This could require, for example, that Manager 1 is notified of information directly before Manager 2 is notified of information, i.e., there are no intermediate steps. Based on the definitions of the relations introduced above, it can also be inferred that Notify_of_information_1 is before the Review request step 114 and after the Check Address step 116, as shown in FIGS. 11A, B, and C and FIG. 13. Other semantic relations can also be inferred, depending on the definitions employed. The inference may be performed with Hermit (http://hermit-reasoner.com/in), as in the illustrated case, and visualized with Protégé.

The lifting step of the process (S120) includes defining which individuals (objects) and respective semantic relations are to be lifted. For example, assuming that the first and second Notify of information steps 110, 112 in the DSL layer 98 shown in FIG. 10 are to be lifted to the global layer 94, as well as the Check Address and Dispatch to organization steps 116, 118, and that the predicates that link them (e.g., (Notify_of_Information_1_DSL, directlyBefore, Notify_of_Information_2_DSL)) are also lifted. Then instances are created in the global context and are linked through mapsTo predicates to the corresponding ones in the DSL space. Using the same inference rules as before, the global context includes inferred information, as shown in FIG. 14.

The different layers 96, 98, 100 are kept separate until a user with appropriate rights decides that he wants to lift specific parts of the information to the global context 94.

At this point in the example, the SRC knows that, because of the information lifted from the DSL local context 98 to the global context 94, Notify of information 1 is before Notify of information 2 in the global context.

Assume that a user that operates in the BPMN domain specific layer 36 then decides to modify the relation between these two tasks (steps) in the BPMN part, denoting that they are to occur inParallel. If this part of the BPMN model is then lifted from the corresponding local context 100 to the global context 94, an inconsistency 102 will be detected (S122). This is because the information coming from the DSL layer 98 has asserted that Notify of information 1 is before the Notify of information 2 step while the information coming from the BPMN layer 100 asserts that the same two steps are inParallel. The mapping of the two instances coming from different local contexts to the same instance in the global context is achieved through the CB layer 66 in the non-SRC space that receives and stores information each time a change is made to an artifact in one layer, and links the change information to the information generated previously when the corresponding information was transformed to that layer from another layer via the meta-model.

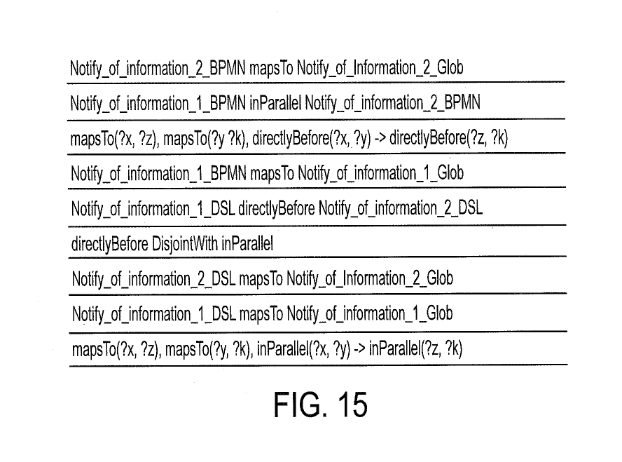

In the example, the predicates directlyBefore and inParallel have been defined as disjoint at S110. FIG. 15 illustrates the inference process leading to detection of an inconsistency 102.

The example above illustrates how the global context 94 can help to keep a consistent state across the different layers. This can be very useful in business process graphical editors 38, 40, 42 because it can simplify automatic validations (with errors shown on the graphical model).

The exemplary system and method find use in the systematic management of business artifacts (e.g., domain-specific concepts, domain processes and BPMN). It does so by introducing a unified semantic layer 94 (and hence inferencing capabilities) on top of domain-specific concepts as well as external concepts inherent to BPMN-based tools, which intrinsically do not allow this kind of semantic representation. This provides the foundation for improved search capabilities as well as consistency checks across the organization's business processes, in ways that could not be achieved with current approaches without extensive human work, which is generally not scalable to the enterprise level. This enables business processes to be managed and checked for consistency, through searchable repositories of business artifacts that provide an up-to-date and accessible view of the organization's business processes to all concerned stakeholders.

The system and method assist users in understanding an organization's processes, by providing a unified semantic representation on top of heterogeneous business artifacts not generally amenable to this kind of semantic interpretation.

The system and method is not limited to the layers illustrated herein but may also find use in connection with the layers of the SOA 58. For example, the system and method can provide further advances in business architecture governance by further enriching the semantic mechanisms in order to embed semantic bridges to the IT layer, hence enabling search and inference mechanisms not restricted to business concepts but involving business concepts and IT capabilities together.

The system and method may also contribute to an organizational process definition (the purpose of which is to establish and maintain a usable set of organizational process assets, work environment standards, and rules and guidelines for a team) and to organizational process pocus (the purpose of which is to plan, implement, and deploy organizational process improvements based on a thorough understanding of current strengths and weaknesses of the organization's processes and process assets), which both may be implemented through a process improvement training and appraisal program, such as Capability Maturity Model Integration (CMMI) Level 3.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for semantic representation of artifacts comprising:
receiving artifact data comprising:
transformation data representing transformations of respective artifacts from a source one of a plurality of domain-related languages to a target one of the plurality of domain-related languages, and
modification data representing at least one modification in one of the source and target domain-related languages for one of the artifacts for which transformation data has been received;
based on the received artifact data, generating a semantic representation comprising objects representing the artifacts and associated transformations and modifications, at least some of the objects being associated with respective local contexts which each denote a respective one of the plurality of domain-related languages;
enriching at least some of the objects in the semantic representation with inferences based on defined inference definitions;
providing for identifying an inconsistency between objects having different local contexts, the inconsistency being based on the inferences associated with the objects;
wherein at least one of the generating of the semantic representation, enriching the objects in the semantic representation, and providing for identifying an inconsistency is performed with a processor.

2. The method of claim 1, further comprising providing for lifting objects and their respective local contexts to a global context, the lifting also lifting inferences associated with the lifted objects and wherein the providing for identifying an inconsistency is performed on objects lifted to the global layer.

3. The method of claim 1, wherein at least some of the inference definitions each require a semantic relation between two objects to be true for an inference to be identified.

4. The method of claim 3, wherein the semantic relation is a temporal relation.

5. The method of claim 4, wherein the inference rules include a plurality of temporal relations selected from is before, is after, is directly after, is directly before, and is in parallel with.

6. The method of claim 5, wherein an inconsistency is identified between a first inference which includes a first relation between respective objects and a second inference which includes a second relation between respective objects and wherein the first and second relations are defined as being disjoint with each other, the objects in the first and second inferences being associated with each other through a transformation and a modification.

7. The method of claim 6, wherein the objects in the first inference are associated with a first of the contexts and the objects in the second inference are associated with a second of the contexts.

8. The method of claim 1, wherein the transformations between pairs of the domain-related languages are all performed using a common meta-model.

9. The method of claim 1, wherein the inference definitions are input by a user.

10. The method of claim 1, further comprising providing for receiving a query and outputting information based on the identified inconsistency.

11. The method of claim 1, wherein the plurality of domain-related languages comprises at least three domain-related languages, the domain-related languages being selected from domain-specific languages and generic languages.

12. The method of claim 1, wherein the domain-related languages include a domain concept level language, a domain process level language, and a generic process level language.

13. The method of claim 1, further comprising receiving artifacts to be transformed from a first editing tool, transforming the received artifacts from a first of the domain-related languages to a second of the domain-related languages, outputting the transformed artifacts to a second editing tool, and generating the transformation data based on the transformations.

14. The method of claim 1, wherein the semantic representation is generated in a web ontology language.

15. A computer program product comprising a non-transitory recording medium storing instructions, which when executed on a computer, causes the computer to perform the method of claim 1.

16. A system comprising memory which stores instructions for performing the method of claim 1 and a processor in communication with the memory for executing the instructions.

17. A system for semantic representation of artifacts comprising:
a semantic representation component which:
a) receives artifact data and inference definitions, the artifact data comprising:
transformation data representing transformations of respective artifacts from a source one of a plurality of domain-related languages to a target one of the plurality of domain-related languages, and
modification data representing at least one modification in one of the source and target domain-related languages for one of the artifacts for which transformation data has been received;
b) generates a semantic representation based on the received artifact data, the semantic representation comprising objects representing the artifacts and associated transformations and modifications, at least some of the objects being associated with respective local contexts which each denote a respective one of the plurality of domain-related languages;
b) enriches at least some of the objects in the semantic representation with inferences based on respective inference definitions; and
c) provides for identifying an inconsistency between objects having different local contexts, the inconsistency being based on the inferences associated with the objects; and
a processor which implements the semantic representation component.

18. The system of claim 17, further comprising a querying and reporting component which receives an input query and outputs information based on the identified inconsistency.

19. The system of claim 17, further comprising a connection bridge, which receives artifacts from a first editing tool, the connection bridge transforming the received artifacts from a first of the domain-related languages to a second of the domain-related languages, outputting the transformed artifacts to a second editing tool, and outputting the transformation data to the semantic representation component.

20. A method for semantic representation of artifacts comprising:
receiving artifacts in a source one of a plurality of languages selected from generic and domain-specific languages from a first editing tool;
transforming the artifacts into a target one of the plurality of languages;
outputting the artifacts in the target language to a second editing tool;
generating transformation data representing the transformations of the respective artifacts from the source language to the target language which link the source artifacts to the target artifacts;
generating a semantic representation based on the transformation data, the semantic representation comprising objects representing the artifacts and associated transformations, at least some of the objects being associated with respective local contexts which each denote a respective one of the plurality of languages;
enriching at least some of the objects in the semantic representation with inferences based on a set of inference definitions; and
providing for outputting information based on the inferences;
wherein at least one of the generating of the semantic representation, enriching the objects in the semantic representation, and providing for outputting information is performed with a processor.
